(19) United States
(12) Patent Application Publication
(10) Pub. No.: US 2010/0289202 A1
(43) Pub. Date: Nov. 18, 2010

(54) Heat-Shrinkable Tube Holder and Method for Inserting Cables Into Heat-Shrinkable Tubes

(76) Inventor: Franz Cordes, Rodermark (DE)

Correspondence Address: STITES & HARBISON PLLC, 1199 NORTH FAIRFAX STREET, SUITE 900, ALEXANDRIA, VA, 22314, US

(21) Appl. No.: 12/864,048

(22) PCT Filed: Jan. 20, 2009
(86) PCT No.: PCT/EP09/00314

§ 371 Date: Jul. 22, 2010

(30) Foreign Application Priority Data
Jan. 22, 2008 (DE) 102008005448.8

(51) Int. Cl. B23Q 1/64; B23Q 7/00

(52) U.S. Cl. 269/56; 29/559

(57) ABSTRACT

A heat-shrinkable tube holder (10) is used to print unshrunk heat-shrinkable tubes (14) held in a printer. The holder (10) comprises a flat transport material and holds the heat-shrinkable tubes (14) at certain distances, wherein two tongues (22) of the carrier material (12) are placed into the two ends of each heat-shrinkable tube (14). In order to simplify handling, it is proposed that at least one of the two tongues (22) has a slot (24) at the center. Such a heat-shrinkable tube holder (10) can be used to easily insert a cable (26) into the respective heat-shrinkable tube (14) after printing of the heat-shrinkable tubes while the heat-shrinkable tubes (14) is still positioned on the holder (10).

The present invention relates to a heat-shrinkable tube holder, containing not-yet shrunk shrinkable tubes, which can be inserted into printers, by means of which the heat-shrinkable tubes held in the latter can be imprinted, wherein the holder, consisting of a flat support material, holds the flattened heat-shrinkable tubes being releasable from the holder at defined intervals for drawing onto and subsequent heat-shrinking onto cable ends, and two tongues of the support material per heat-shrinkable tube are inserted into two ends of each heat-shrinkable tube. A method for imprinting such heat-shrinkable tubes and for inserting cables into the imprinted heat-shrinkable tubes is also subject of the present invention.

Heat-shrinkable tubes are employed for marking the ends of electrical cables in technical appliances and installations. To this end, the heat-shrinkable tubes are initially marked with letters prior to being placed and shrunk onto the cables, which in connection with large numbers of pieces takes place with the aid of printers. In order to be able to imprint the heat-shrinkable tubes exactly in the printers, it is customary to arrange them on heat-shrinkable tube holders, such as described at the outset. Simple shrinkable tube holders are known from U.S. Pat. No. 3,958,852, for example. The support material there has spaced-apart, long tongues, onto which the individual heat-shrinkable tubes have been pushed in definite layers. Here, the tongues extend through the entire heat-shrinkable tube in order to stabilize it for transporting and imprinting in a printer. For subsequent use the imprinted heat-shrinkable tubes are pulled off the tongues and thereafter threaded onto the cable ends. It is disadvantageous in connection with this solution that the heat-shrinkable tubes do not always take up an exactly defined position on the tongues and, as a result of the fixation of the tongues on the support material at only one end, additional yielding spots exist in the heat-shrinkable holder, which negatively affect the quality of the print image.

Solutions are also known in which the flattened heat-shrinkable tubes have been glued onto a continuous support material. In connection with this solution it is disadvantageous that the heat-shrinkable tube can only be imprinted on one side, so that later, in an unfavorable installed position with a limited viewing angle, the imprint can either not be distinguished at all or only with difficulty. Also known are solutions in which the heat-shrinkable tube itself constitutes a portion of the heat-shrinkable tube holder in that the support is glued in two parts to the respective ends of the heat-shrinkable tube. Although the imprintably on two sides of the heat-shrinkable is provided here, the removal of the heat-shrinkable tube from the two halves of the heat-shrinkable tube holder is very arduous. The threading of the cables into heat-shrinkable tubes glued together with the heat-shrinkable tube holder in such a way is elaborate, because it often becomes difficult to initially widen the flattened heat-shrinkable tubes at their ends at all in order to insert the cable.

A heat-shrinkable tube holder of the type mentioned at the outset is known from Canadian Patent No. 1,262,045. Such a heat-shrinkable tube holder offers better stability for the heat-shrinkable tubes, but the two tongues block the end of the heat-shrinkable tubes, so that they must be removed from the holder prior to being drawn on the wire. Thus, regarding the drawing on of the wire there is no improvement in handling in comparison with holders with only one tongue protruding through the heat-shrinkable tube. A similar heat-shrinkable tube holder is known from Canadian Patent No. 1,293,476.

Canadian Patent Application CA 2,184,462 A1 shows a printer for imprinting heat-shrinkable tubes which are held in a heat-shrinkable tube holder, in which the two tongues extend almost completely through the heat-shrinkable tube and are only separated by a narrow slit. Finally, shrinkable packagings are known from DE 91 01 027 U1 and DE 73 38 058, in which already shrunk, tube-shaped packaging elements are held on tongues for forming a package. This represents a different use, and the packages represented there are not suited for later imprinting in a printer.

The object of the present invention lies in providing a heat-shrinkable tube holder which makes possible imprinting of the heat-shrinkable tubes on both sides, and at the same time simplifies their manipulation when drawing them up onto the cable ends.

This object is attained in accordance with the invention in that in a heat-shrinkable tube holder of the type described at the outset one of the two tongues per heat-shrinkable tube has a slit in the center.

The heat-shrinkable tube holder in accordance with the invention offers the advantage that, on the one hand, the heat-shrinkable tubes are fixed, stably seated in place on the support material, by means of the two separate tongues, so that a satisfactory imprinted image can be achieved. Because of being held via the centrally acting tongues, imprinting of the heat-shrinkable tubes on both sides is easily provided, because the tube is also automatically centered. The heat-shrinkable tube can also easily be drawn off the tongues on both sides because, although the support material has sufficient strength for fixing the heat-shrinkable tube in place in the printer, the tongues yield under specific loads.

The slit in at least one of the two tongues assures that it is possible without problems to introduce a cable at this location, in particular since, because of the tongue, the two layers of the heat-shrinkable tube are held apart, even in the flattened state, by at least the thickness of the support material. Thus the advantage results that the cable can be introduced directly into the heat-shrinkable tube, which is still connected to the support material, and the tube can then be easily separated from the heat-shrinkable tube holder with the aid of the cable.

In a preferred embodiment of the invention it has been provided that both tongues have a central slit. In this way the user is not dependent on the side from which he approaches the heat-shrinkable tube with the cable, in this connection the advantage should also be mentioned that both left-handed and right-handed people can use the heat-shrinkable tube holder equally easily. Also, advantages in the course of threading result in that, because of the slit on the opposite side, the introduced cable can easily be pulled out of the heat-shrinkable tube.

The heat-shrinkable tubes are preferably each arranged in recesses of the support material on whose ends the tongues are arranged. An improved stability results in this embodiment, in which the heat-shrinkable tubes are completely enclosed by the support material, which has a positive effect on the printing quality and the manipulation of the heat-shrinkable tube holder in the printer.

The slits preferably extend past the tongues into the transport material in order to have sufficient space available, even for the introduction of rigid cables.

In connection with the case in which drawing of the heat-shrinkable tubes onto the cable ends is intended to take place spatially separated from imprinting, an embodiment is advantageous in which the support material has separating seams between the holding areas of an individual heat-shrinkable tube for easier separation. Such a separating seam, which for example can be constituted by a perforation, permits the separation of the entire holding area, so that the advantages in connection with threading the cable into the heat-shrinkable tube can also be used, independent of the imprinting of the heat-shrinkable tube holder, at a different location.

Plastic foil has been shown to be a suitable type of material for the support material, but it is also basically possible to employ paper materials as the support material, provided they are of sufficient strength.

The support material preferably has recesses for the engagement of transport means, which make the precise transport of the heat-shrinkable tube holder in the printer possible. The perforation is preferably arranged in the area of the separating seams in order not to weaken the entire heat-shrinkable tube holder excessively, and to simplify the design of the perforation.

A method for imprinting a heat-shrinkable tube and for threading a cable, which is employed for purposes of marking, into this heat-shrinkable tube, is also the object of the instant invention. In accordance with the invention it has been provided for the heat-shrinkable tubes to be maintained at defined distances from each other in a heat-shrinkable tube holder, wherein the tongues of the holder engage the heat-shrinkable tubes from both sides, the holder is transported through a printer, in which the heat-shrinkable tubes are imprinted on one or both sides, the cables are inserted into the heat-shrinkable tubes through a slit arranged centered in at least one of the tongues, and finally, while the tongues are deformed, the heat-shrinkable tube is pulled out of the holder with the aid of the cable.

The method offers the advantage that it is possible to insert the cable directly into the heat-shrinkable tube while it is still fixed in place in the holder, while the interior of the heat-shrinkable tube is spread open by the slit tongue, and the insertion of the wire end is thus made easier. A further development of the invention can provide that the heat-shrinkable tube can be cut open in sections for each heat-shrinkable tube, and a heat-shrinkable tube, along with the holding area for threading the cable provided for this, is cut off the remaining heat-shrinkable tube.

An exemplary embodiment will be discussed in greater detail in what follows by means of the attached drawings. Shown are in:

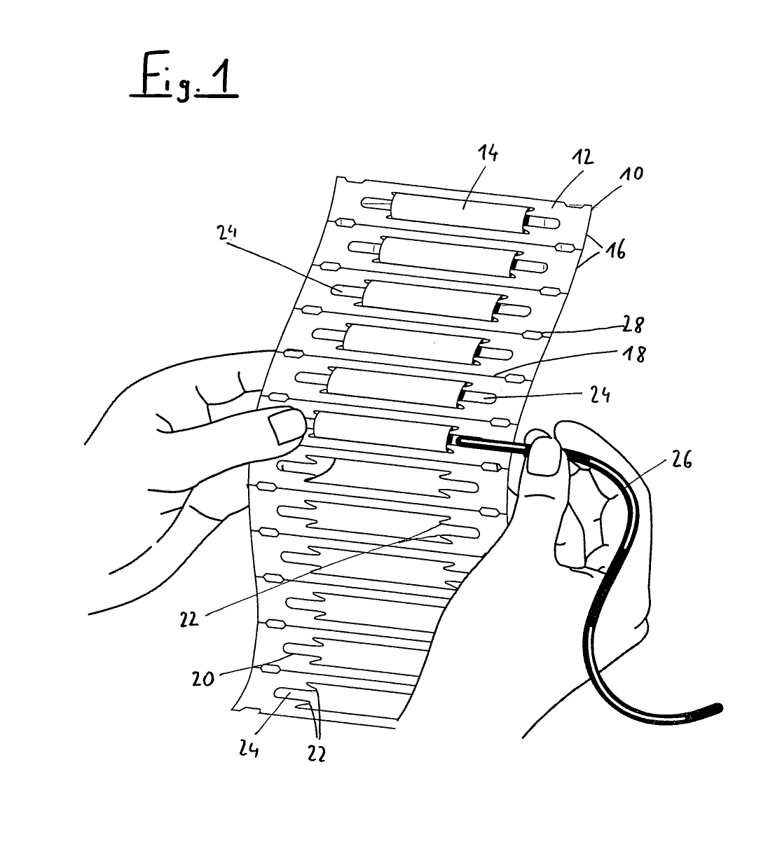

FIG. 1, a representation of the threading of a cable into a heat-shrinkable tube,

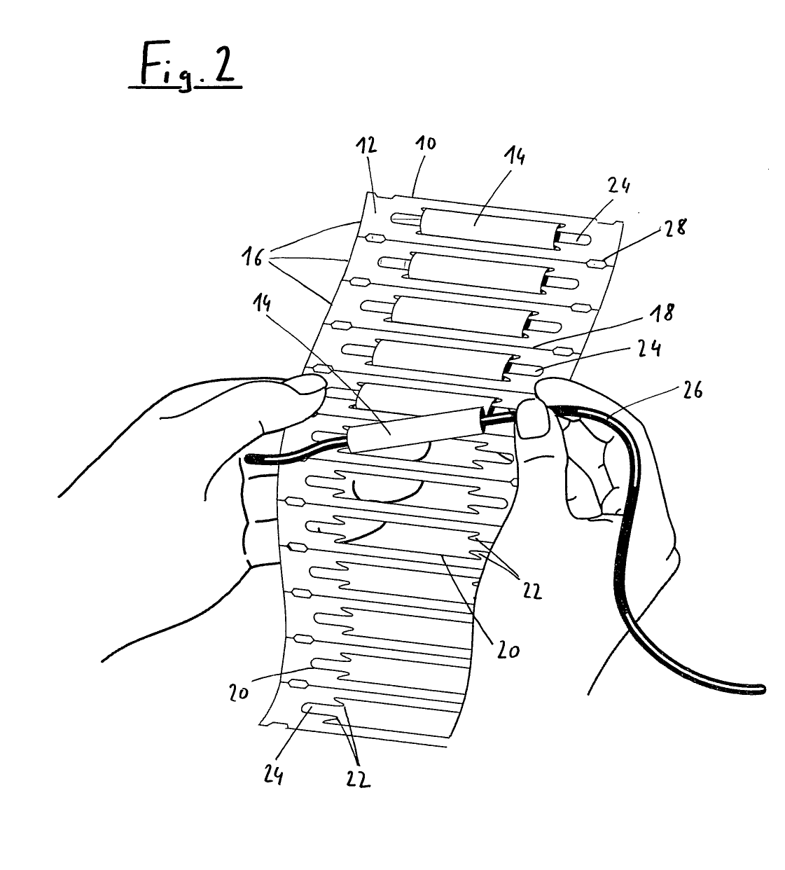

FIG. 2, a representation similar to FIG. 1, following the removal of the heat-shrinkable tube from the holder.

FIG. 1 shows a representation of how a heat-shrinkable tube holder 10, embodied as an endless holder and stored on a roll, for example, is removed from a corresponding suitable endless printer. The printer itself is not subject of the present invention and has therefore not been represented.

The heat-shrinkable tube holder 10 is made of a flat plastic support material 12, and each heat-shrinkable tube 14 is assigned its own holding area 16, and the individual holding areas can be separated from each other by respectively one separating seam 18 formed, for example, by a perforation. Cut-outs 20, along whose respective edge areas tongues 22 extend, which project into the flattened heat-shrinkable tubes 14, are provided in the separate holding areas. In the center, the respective tongues 22 have a slit 24, which extends toward the rear past the tongues into the support material. The slits 24 are formed in the support material 12 on both sides of the heat-shrinkable tubes, however, embodiments with only one slit, and correspondingly with one continuous tongue on the opposite side, are also possible.

The slit tongues simultaneously maintain the two walls of the flattened heat-shrinkable tubes 14 apart from each other at a distance corresponding at least to the thickness of the support material 12. By means of this the threading-in of a cable 26, such as represented in FIG. 1, is simplified, in connection with which it should be noted as a further advantage that it is possible to hold the cable 26 with one hand, and the support material 12 with the other, so that threading-in appears to be considerably easier than with a heat-shrinkable tubes 14 already previously separated from the support material. After the cable 26 has again been threaded out of the heat-shrinkable tube through the oppositely located slit 24, it is possible to remove the heat-shrinkable tube 14 from the heat-shrinkable tube holder 10. In this case the tongues 22 yield laterally, so that the heat-shrinkable tube 14 is not damaged.

The heat-shrinkable tube holder 10 has cut-outs 28, which are respectively arranged in the area of the separating seams 18 and with the aid of which it is possible to exactly position the heat-shrinkable tube holders 10, and along with them also the associated heat-shrinkable tubes 14, in the printer, in which case the advancement also takes place by taking along the edges of the cut-outs 28.

As can be easily seen from FIGS. 1 and 2, it is possible to imprint the heat-shrinkable tube 14 on both sides, since it is received in the open cut-outs 20, so that satisfactory readability of the markings after mounting is provided under all circumstances.

After the removal, represented in FIG. 2, of the heat-shrinkable tube 14 from the holder 10, it is only necessary to briefly heat it in the customary manner, so that it contracts and is held on the cable end without danger of being lost.

1. A heat-shrinkable tube holder with not-yet shrunk heat-shrinkable tubes, which can be inserted into printers, by means of which the heat-shrinkable tubes held in the latter can be imprinted, wherein the holder, consisting of a flat support material, holds the flattened heat-shrinkable tubes being releasable from the holder at defined intervals for drawing onto and subsequent heat-shrinking onto cable ends, and two tongues of the support material per heat-shrinkable tube are inserted into two ends of each heat-shrinkable tube, characterized in that at least one of the two tongues has a centered slit.

2. The heat-shrinkable tube holder in accordance with claim 1, characterized in that each one of both tongues has a centered slit.

3. The heat-shrinkable tube holder in accordance with claim 1, characterized in that each of the heat-shrinkable tubes is seated in a cut-out of the support material, on the ends of which cut-out the tongues are arranged.

4. The heat-shrinkable tube holder in accordance with claim 1, characterized in that the slits extend past the ends of the tongues into the support material.

5. The heat-shrinkable tube holder in accordance with claim 1, characterized in that, between the holding areas, the support material has separating seams for individual heat-shrinkable tubes.

6. The heat-shrinkable tube holder in accordance with claim 5, characterized in that the separating seams are formed by perforations.

7. The heat-shrinkable tube holder in accordance with claim 1, characterized in that the support material consists of a plastic foil.

8. The heat-shrinkable tube holder in accordance with claim 1, characterized in that the support material has cut-outs for the engagement of transport means.

9. The heat-shrinkable tube holder in accordance with claim 8, characterized in that the transport cut-outs are arranged in the area of the separating seams.

10. A method for imprinting heat-shrinkable tubes and for threading a cable into the heat-shrinkable tubes, wherein the heat-shrinkable tubes are held on a heat-shrinkable tube holder at defined distances from each other, characterized in that tongues of the holder engage the heat-shrinkable tubes from both sides, the holder is transported through a printer, in which the heat-shrinkable tubes are imprinted on one or both sides, the cables are inserted into the heat-shrinkable tube through a slit arranged in at least one of the tongues, and finally, while the tongues are deformed, the heat-shrinkable tube is pulled out of the holder with the aid of the threaded-in cable.

11. The method in accordance with claim 10, characterized in that the heat-shrinkable tube holder can be cut open in sections for each heat-shrinkable tube, and a heat-shrinkable tube, along with the holding area assigned to it, is cut off the remaining heat-shrinkable tube holder prior to threading the cable.
